(19) United States
(12) Patent Application Publication
(10) Pub. No.: US 2019/0188346 A1
(43) Pub. Date: Jun. 20, 2019

(54) SYSTEM AND METHOD FOR MODELING CHARACTERISTICS OF A MELT POOL THAT FORMS DURING AN ADDITIVE MANUFACTURING PROCESS

(71) Applicant: Siemens Product Lifecycle Management Software Inc., Plano, TX (US)

(72) Inventors: Lucia Mirabella, Plainsboro, NJ (US); David Madeley, Louth (GB); Sanjeev Srivastava, Princeton Junction, NJ (US)

(21) Appl. No.: 16/330,191

(22) PCT Filed: Mar. 31, 2017
(86) PCT No.: PCT/US2017/025361

§ 371 Date: Mar. 4, 2019

Related U.S. Application Data
(60) Provisional application No. 62/396,375, filed on Sep. 19, 2016.
(60) Provisional application No. 62/396,440, filed on Sep. 19, 2016.

(51) Int. Cl. G06F 17/50; B33Y 50/00; B23K 26/354; B23K 26/34

(52) U.S. Cl. CPC G06F 17/5018; B33Y 50/00; G06N 3/08; B23K 26/34; B23K 26/354

(57) ABSTRACT

A system and method is provided for modeling characteristics of a melt pool that forms during an additive manufacturing process. The system may include at least one processor configured to generate a data-driven model capable of predicting melt pool temperature and melt pool area for target deposit location points along at least one tool path for a three dimensional (3D) printer at which a laser of the 3D printer melts new deposits of material to buildup a product. The generation of the data-driven model may be based at least in part on melt pool temperatures and melt pool areas for a selected nearest subset of a plurality of previous deposit location points along the at least one tool path. The nearest subset may be selected based on determined spatio-temporal distance between a respective target deposit location point and each of the plurality of previous deposit location points along the at least one tool path.

### TECHNICAL FIELD

The present disclosure is directed, in general, to computer-aided design (CAD), computer-aided manufacturing (CAM), computer-aided engineering (CAE), visualization, simulation, and manufacturing systems, product data management (PDM) systems, product lifecycle management (PLM) systems, and similar systems, that are used to create, use, and manage data for products and other items (collectively referred to herein as product systems).

### BACKGROUND

Product systems may be used to simulate manufacturing of products. Such systems may benefit from improvements.

### SUMMARY

Variously disclosed embodiments include data processing systems and methods that may be used to facilitate modeling characteristics of a melt pool that forms during an additive manufacturing process. In one example, a system may comprise at least one processor configured to generate a data-driven model capable of predicting melt pool temperature and melt pool area for target deposit location points along at least one tool path for a three dimensional (3D) printer at which a laser of the 3D printer melts new deposits of material to buildup a product. The generation of the data-driven model may be based at least in part on melt pool temperatures and melt pool areas for a selected nearest subset of a plurality of previous deposit location points along the at least one tool path. The nearest subset may be selected based on determined spatio-temporal distance between a respective target deposit location point and each of the plurality of previous deposit location points along the at least one tool path.

In another example, a method for modeling characteristics of a melt pool that forms during an additive manufacturing process may comprise acts carried out through operation of at least one processor that correspond to the functions for which the previously described at least one processor is configured to carry out.

A further example may include a non-transitory computer readable medium encoded with executable instructions (such as a software component on a storage device) that when executed, causes at least one processor to carry out this described method.

Another example may include a product or apparatus including at least one hardware, software, and/or firmware based processor, computer, component, controller, means, module, and/or unit configured for carrying out functionality corresponding to this described method.

The foregoing has outlined rather broadly the technical features of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiments disclosed as a basis for modifying or designing other structures for carrying out the same purposes of the present disclosure. Those skilled in the art will also realize that such equivalent constructions do not depart from the spirit and scope of the disclosure in its broadest form.

Also, before undertaking the Detailed Description below, it should be understood that various definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

FIG. 1 illustrates a functional block diagram of an example system that facilitates modeling characteristics of a melt pool that forms during an additive manufacturing process.

FIG. 2 illustrates a block diagram of a data-driven reduced order model based on weighted impact factors for prediction of a melt pool area and a melt pool temperature (at a time of laser beam impact) at a next printing location.

FIG. 3 illustrates a block diagram of a data-driven reduced order model based on an artificial neural network for prediction of a melt pool area and a melt pool temperature (at a time of laser beam impact) at a next printing location.

FIG. 4 illustrates a flow diagram of an example methodology that facilitates modeling characteristics of a melt pool that forms during an additive manufacturing process.

FIG. 5 illustrates a block diagram of a data processing system in which an embodiment may be implemented.

### DETAILED DESCRIPTION

Various technologies that pertain to systems and methods that facilitate modeling characteristics of a melt pool that forms during an additive manufacturing process will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

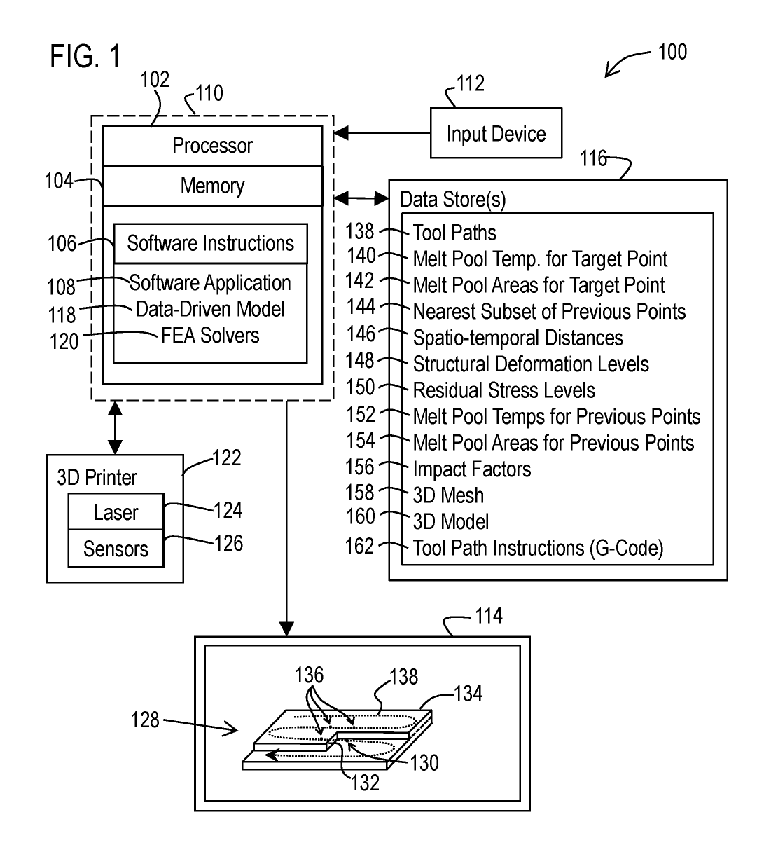

With reference to FIG. 1, an example data processing system 100 is illustrated that facilitates carrying out one or more of the embodiments described herein. The system 100 may include a combination 110 of at least one processor 102 (e.g., a microprocessor/CPU) that is configured to carry out various processes and functions described herein by executing from a memory 104, software instructions 106 corresponding to one or more software applications 108 or portions thereof that are programmed to cause the at least one processor to carry out the various processes and functions described herein.

Such a memory 104 may correspond to an internal or external volatile memory (e.g., main memory, CPU cache, and/or RAM), that is included in the processor and/or in operative connection with the processor. Such a memory 104 may also correspond to a nonvolatile memory (e.g., flash memory, SSD, hard drive, or other storage device or non-transitory computer readable media) in operative connection with the processor.

The described data processing system 100 may include at least one input device 112 and at least one display device 114 in operative connection with the processor. The input device, for example, may include a mouse, keyboard, touch screen, or other type of input device capable of providing user inputs to the processor. The display device, for example, may include an LCD or AMOLED display screen, monitor, or any other type of display device capable of displaying outputs from the processor. For example, the processor 102, memory 104, software instructions 106, input device 112, and display device 114, may be included as part of a data processing system corresponding to a PC, workstation, server, notebook computer, tablet, mobile phone, or any other type of computing system, or any combination thereof.

The data processing system 100 may also include one or more data stores 116. The processor 102 may be configured to manage, retrieve, generate, use, revise, and store data and/or other information described herein from/in the data store 116. Examples of a data store may include a database (e.g., Oracle, Microsoft SQL Server), file system, hard drive, SSD, memory card and/or any other type of device or system that stores non-volatile data.

In example embodiments, the software application 108 may include one or more PLM software applications that may be adapted to carry out one or more of the processes and functions described herein. PLM software may include computer-aided design (CAD), computer-aided manufacturing (CAM), and computer-aided engineering (CAE) software. Examples of such PLM software applications may include the NX suite of applications, Solid Edge software, and/or Teamcenter software, produced by Siemens Product Lifecycle Management Software Inc., of Plano, Tex., US. However, it should be appreciated that the processes and functions described herein may be carried out using other product systems that manage, retrieve, generate, use, revise, and/or store product data.

Such PLM software applications may be configured to generate tool path instructions 162 (e.g., G-code or other instructions) that are usable by three-dimensional (3D) printers to produce parts based on 3D models (e.g., solid models, 3D CAD models, and/or geometric models) of the parts. It should be understood that a 3D printer 122 corresponds to a machine capable of additively manufacturing (i.e., producing) 3D articles (i.e., a part) by depositing materials which bind together to form the physical structure of the part. Examples of additive manufacturing processes employed by 3D printers to build 3D parts using a high power laser 124 or electron beam to selectively sinter or melt a powdered material (typically metallic) include: selective laser sintering (SLS), selective laser melting (SLM) and directed energy deposition (DED). Other types of 3D printers may apply other techniques for selectively depositing material to additively build up a part. Also, it should be understand that the phrase to “build up” does not require the material to be built up only in a vertical upward direction, but may include building up the part in a horizontal direction as well as building up the part in a vertical downward direction, depending on the technology of the 3D printer that is used.

The geometric accuracy and mechanical performance of a 3D printed part may be influenced by the raw material and process parameters that may make the final part deviate from the original design. As a part is being manufactured, the higher energy heat source of some additive manufacturing processes may introduce thermal distortion and residual stress. For example, due to the presence of thermal gradients during heating and cooling, these processes may introduce residual stress, which can cause deformations (warping) and/or cracks on the part as the part cools. The presence of these defects can hinder tolerance and affect mechanical strength. However, the location and magnitude of such deformations are not always predictable based on the shape of the part, especially for complex geometries and complex melting paths (i.e., the laser tool paths).

To accurately predict such phenomena, CAE components of the application software 108 may be used to simulate the manufacturing process, from the thermal and mechanical point of view. Example embodiments may enable modeling and simulation of additive manufacturing processes in order to predict the quality of the printed object that will be produced by the actual physical additive manufacturing process.

In an example embodiment, the processor may be configured to carry out the simulations of additive manufacturing processes using 3D models 160 of products (e.g., data specifying mathematical representations of a 3D volume/surface of objects such as solid models and shell/boundary models). Such 3D model data may be accessed from the data store 116 and/or from files (e.g., in a CAD format such as JT or STEP, or other format for storing geometric curves that define the shape of the part). In addition, it should also be appreciated that the 3D model data may be generated from a 3D scan of an existing physical part.

In some approaches, the processor may generate a mesh 158 of the 3D model (such as a Cartesian hexahedral mesh having vertices/nodes and their connections) that partitions the space of the part into a plurality of 3D elements (e.g., hexahedron shaped cells or zones). In other examples the determined mesh may be comprised of tetrahedrons, polyhedrons, or other 3D shapes)

In example embodiments, the hexahedron shaped elements that make up the mesh may have dimensions based on configuration data for the 3D printer that is desired to produce the part. For example, the height of the hexahedron elements for the mesh may correspond to one or more thicknesses of layers of material that the 3D printer is capable of depositing. Also for example, the width of the hexahedron elements may correspond to the width of the material that the tool of the 3D printer is capable of depositing. For a 3D printer that uses a laser, such a width of the hexahedron elements may correspond to a laser beam diameter, which corresponds to the width of the powder that the laser is capable of sintering/melting as it moves along a tool path. In some embodiments, the hexahedron elements width or height may also be restricted by the geometry at the areas closer to the surface of the part.

In an example embodiment, the processor may be configured to determine an order of the elements of the mesh to deposit to simulate additively producing (i.e., building up) the part based on a set of tool paths 138. For example, the order of the elements deposited may be based on a determination as to which hexahedrons of the hexahedral mesh intersect with an output of a tool (e.g., laser beam output) of the 3D printer as the tool follows the set of tool paths 138 in order to add material (e.g., via sintering or melting powder) to form the part.

As used herein, the term deposit or depositing refers to the generation of additional material that is deposited onto the build plate and addition portions of the part. Thus a deposition head of a DED 3D printer that both outputs and melts powder, is to be understood as carrying out a process of depositing the melted powder in a particular location. Similarly, for SLS and SLM 3D printers that both inclemently apply a layer of powder followed by selectively sintering or melting portions of the powder, depositing of material corresponds to sintering or melting powder in a particular location. In addition, it should be noted that many of the examples described herein are with respect to SLS type 3D printers. However, it should be appreciated that the described framework may be adapted for other types of additive manufacturing processes and 3D printers, by modifying the input parameters provided and the boundary conditions.

In example embodiments, the determined tool paths 138 and mesh 158 may be stored in the memory 104 and/or the data store 116 for use with the functions described herein. In addition, data regarding the shape of the part from the 3D model 160 may be stored in the memory and/or data store, which is usable by the processor to determine the tool paths and the mesh.

The described software application 108 may include CAD/CAM/CAE components capable of generating all three of the 3D model, 3D mesh, and tool paths. However, it should also be appreciated that one or more of this information may be generated by different systems/software and saved to one or more data stores 116 that are accessible to the at least one processor 102 that carries out the described simulation.

In this described approach, to carry out the simulation, the processor 102 may simulate an incremental deposit of each of the elements of the mesh in the order that the elements are determined to be deposited. For each incremental deposit of an additional respective element, the at least one processor may use finite element analysis solvers 120 (e.g., which may be included with the software application 108) to determine thermal gradients, structural deformation levels (warping), and residual stress (e.g., Von Mises stress) associated with each newly deposited element and previously deposited elements.

Based on the results of one or more simulations and data produced therefrom, strategies (e.g., modified tool paths, modified process parameters, and/or modifications to the structure and/or material of the product) may be employed that reduce warping, before manufacturing the product with the 3D printer. Such modified tool paths may include modifying the locations that the laser moves to ensure underlying material has sufficiently cooled before new material is sintered or melted thereon. Also, for example, modified tool paths may be generated that cause support structures to be additively built that minimize warping at identified locations on the product and that may be readily removed after the part is complete. In addition, useful modifications to the product that are determined or identified by the application software component may include thickening of a portion of the product to compensate for undesirable warping of material identified in an initial set of tool paths. Identifying and/or automatically generating such modified tool paths or modified design of the product, may minimize defects in the product and may reduce manufacturing costs and time for performing such analysis in an experimental setting.

However, a possible impedance to the wide-spread use of such simulations may be the lengthy computation time of such simulations. Increasing the time-varying computational domain with more combinations of variables may introduce additional complexity to the simulation of the 3D model of the product and significantly increase the amount of time to perform the simulations. In particular for example, computational cost may increase dramatically during the course of the simulation, as more material is being added to the computational domain of the simulation.

Also, additive manufacturing processes are intrinsically multi-scale in space and time. For example, the melting pool area may be on the order of microns, while the observable defects are of the order of millimeters, and the printed part can be of the order of meters. Hence, choosing a space discretization mesh that is able to capture the melt pool scale can result in the simulation of the printing process of the full 3D part that lasts many hours or even days to run on a desktop/workstation type of system. Similarly, timescales of the manufacturing process can range from hours for a global heat treatment during manufacturing to minutes for building a single-layer and milliseconds for the interaction time between the laser beam and the material. Moreover, an accurate model to predict the shape and temperature at the melt pool level may need computationally expensive calculations, even when the considered geometry is at the millimeters scale.

In one possible approach to attempt to reduce computation time, a solver may be configured to perform adaptive mesh refinement and de-refinement during the finite element simulation. During the simulation, a quadrilateral mesh of the part may be automatically refined at the heated region to ensure the heated region is solved with fine resolution. As the heat source moves farther away (in the build direction) from earlier deposited layers, the fine mesh coarsens to reduce the computational cost. This approach may reduce the computational cost of the simulation while preserving details at local regions. However, this approach may require a complicated mesh refinement algorithm at each step (e.g., each incremental addition of a quadrilateral element to the mesh) to coarsen portions of the mesh, and additional computational resource may be spent to perform the mesh refinement and de-refinement operations. Also this approach may include an ongoing data transfer between coarse and fine mesh during the simulation, which may require computational resources. In addition, this approach does not address the computational cost of the accurate resolution of the melt pool physics using a fine resolution in the hotter regions of the mesh.

The following described example embodiments provide approaches that may be operable to further reduce the computational resources required to simulate additive manufacturing processes and hence shorten the simulation time. These approaches may be used in conjunction with adaptive meshing techniques, or as a standalone solution.

In one example embodiment, a system 100 may be configured to process experimental data acquired during an additive manufacturing process, in terms of time, temperature, melt pool area, and process parameters. The system may be configured to derive based on this dataset, a data-driven reduced order model (DDM) 118 of the melt pool area and melt pool temperature (at the time of laser beam impact) at the next printing location. Such temperature, and melt pool area data may be determined via sensors 126 in the 3D printer that are configured to monitor the melt pool area as a product is being produced via a 3D-printer. In an alternative embodiment, rather than using data from such sensors, sample datasets (e.g., for time, temperature, melt pool area, and process parameters) for deriving DDM may be obtained from high-fidelity validated simulations of the melt pool physics.

In these described embodiments, such a melt pool area corresponds to a measure of the size of the melt pool formed via the laser melting or sintering the material. Such an area may correspond, for example, to a surface area orientated in a plane that is generally normal to the direction of the laser beam. However, in other embodiments, the described/claimed melt pool area may correspond to a space in 3D dimensions that corresponds to the size of the melt pool. The described melt pool temperature may correspond to a temperature in Celsius (or other scale) of the material in the melt pool area.

The DDM may be generated using data analytics techniques, such as machine learning, after preprocessing the data, based on knowledge of the physical phenomenon. For example, for each printing location along predetermined tool paths (as the product is being produced via a physical 3D-Printer or a high-fidelity validated simulation), the following information may be collected and stored in the data store: process parameters at the current location (e.g., x,y,z coordinates); and for locations already printed, process parameters, time of printing (t), melt pool temperature (T), melt pool area (A), location (L in x,y,z coordinates), and type of location (e.g., as one of the following “internal location”, “boundary location”, “proximal to boundary”).

In one example embodiment, such a DDM may be generated based on determined weighted impact factors 156 determined by the system from the datasets. An alternative embodiment may generate the DDM based on an artificial neural network (ANN) trained using the datasets.

It should be understood that the described datasets used to generate these example DDMs may use datasets with less than the information described previously. For example, the following descriptions of generating these DDMs may not include the type of location data and or process parameters for locations already printed. However, alternative versions of these DDMs may be generated based on this information as well.

These examples may use such datasets to generate the DDM, based on the combined spatio-temporal distance of the prediction point to the available data. Such a DDM may be effective based on the physical consideration that the temperature (and melt pool area as a consequence) at a given location is highly influenced by the temperature at locations closed to it, particularly if the printing happened very recently at those locations, as the thermal gradients decrease over time.

FIG. 1 illustrates an overview of these approaches for modeling characteristics of a melt pool that forms during an additive manufacturing process comprising. In some embodiments, the processor 102 may be configured to cause the display device 114 to output determined data associated with the additive manufacturing process. To further understanding of the process, in some embodiments, the display device 114 may output a visual representation 128 of the manufacturing process being carried out to buildup a product 134. However, it should be understood that alternative embodiments may not display such a visual representation or may display other visual representations of the process and/or data produced therefrom.

In these examples, the processor 102 may be configured to generate a DDM 118 capable of predicting melt pool temperature 140 and melt pool area 142 for target deposit location points 130 along at least one tool path 138 for a 3D printer 122 at which a laser 124 of the 3D printer melts new deposits of material 132 to buildup the product 134. In this example, generation of the DDM may be based at least in part on melt pool temperatures and melt pool areas 152, 154 for a selected nearest subset 144 of a plurality of previous deposit location points 136 along the at least one tool path. The nearest subset may be selected based on determined spatio-temporal distance 146 between a respective target deposit location point and each of the plurality of previous deposit location points along the at least one tool path.

It should be understood that the size (e.g., area) of a melt pool may vary based on the temperature of material under and adjacent the current location at which the laser is forming a new melt pool of deposited material. The generated DDM 118 may be used to predict melt pool temperature and melt pool area for current locations along tool paths for a 3D printer at which a laser of the 3D printer melts new deposits of material to buildup the product. Based at least in part on the predicted melt pool temperatures and melt pool areas, the processor may be configured to determine changes in temperature over time across the product, resulting structural deformation levels 148 and residual stress levels 150 in the product.

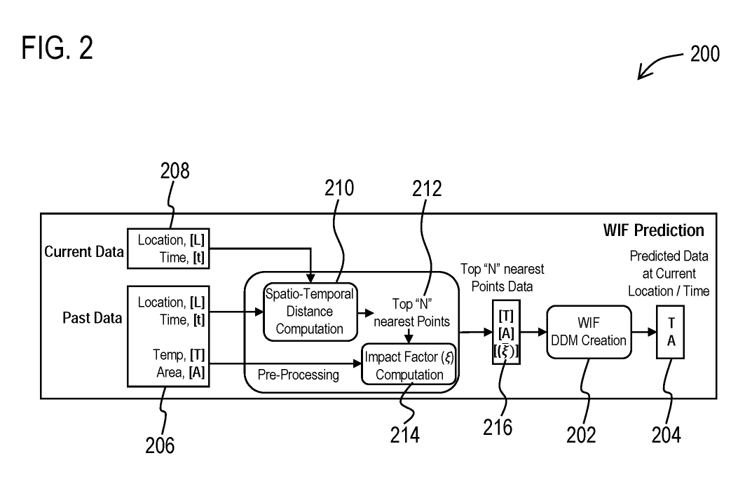

FIG. 2 shows a block diagram 200 of a process for generating a DDM 202 that is based on weighted impact (WIF) factors 216. Such a WIF DDM 202 may be created and used to generate predications 204 for melt pool temperatures and melt tool areas at points along the tool paths (used by a 3D printer to produce a product) by carrying out several steps.

In a first step, the described processor 102 may be configured to use past data 206 (where printing has occurred) and current data 208 (where the printing is going to be performed) to compute a spatio-temporal distance 210 for previously printed points. The current data may correspond to a current location (L) and time (t) along the tool paths for which a prediction of a desired melt pool temperature (T) and melt pool area (A) is desired.

Such past data may correspond to experimental data acquired from sensors in a 3D printer while a product is being printed. For example, the experimental past data may correspond to data acquired via sensors of the 3D printer that detect a melt pool area (A) and a melt pool temperature (T) at different locations (L) and times (t) during the depositing/melting of material along tool paths defined by a set of instructions (e.g., G-code) generated from a 3D model of the product.

However, such past data may also correspond to calculated data generated from a simulation of the 3D printer printing the product which involves finite element analysis of a mesh of the 3D model. For example, the calculated past data may correspond to data acquired from finite element solvers that are configured to determine a melt pool area (A) and a melt pool temperature (T) at different locations (L) and times (t) during the simulation of depositing/melting of material along tool paths defined by the set of instructions (e.g., G-code) generated from the 3D model of the product. Also, it should be appreciated that such past data may come from two or more simulations and/or 3D printer sensor measurements.

In this described example, a spatio-temporal distance (d) 210 for a past point (i) from the past data 206 may be calculated as follows:

d_{Lt}ⁱ=\sqrt{(L_{current}−Lₚₐₛₜⁱ)²+(t_{current}−tₚₐₛₜⁱ)²}

where t=time of printing, and L=location in x,y,z coordinates.

In a second step, the processor 102 may be configured to find “N” nearest points based on computed space-time distances (d) with respect to the current location point specified by the current data 208. N may be a user configurable parameter such as a value between 4-100, or other number based on the type of 3D printer, process parameters and the complexity of the 3D model.

In a third step, the processor 102 may be configured to compute for each “N” nearest points 212 of past data 206 with respect to a current location point 208 along a tool path, an impact factor (ξ) 214. Such impact factors for the “N” nearest points 212 may be a function of the spatio-temporal distance (d) 210, melt pool temperature (T), and melt pool area (A) as follows:

$${ξ}^{i} = \frac{{T}^{i} \cdot {A}^{i}}{{d}_{Lt}^{i}}$$

In a fourth step, the processor 102 may be configured to compute weighted impact factors (ξ̅), such as follows:

$${\overline{ξ}}^{i} = \frac{{ξ}^{i}}{{\sum }_{i = 1}^{N} {ξ}^{i}}$$

In a fifth step, the processor 102 may be configured to use the weighted impact factors (ξ̅), melt pool temperature (T), and melt pool area (A), to create a data driven model 202 that is usable to compute (predict) the melt pool temperature (T) and the melt pool area (A) 204 for the current location point 208 along a tool path. The equations for such a model for, example, may correspond to the following:

$$A = {\sum }_{i = 1}^{N} {\overline{ξ}}^{i} \cdot {A}^{i}$$

$$T = {\sum }_{i = 1}^{N} {\overline{ξ}}^{i} \cdot {T}^{i}$$

It should be understood that the predictions produced by such a model may not be accurate for the first few printing locations due to a lack of data for creating an accurate model. However, the generated predictions may start to improve at a fast rate once current printing location is greater than the Nth printing location.

This approach enables the dynamic selection of data, from data measured up till the prediction, for the generation of a data-driven model to predict characteristics (temperature and area) of the melt pool that forms during the additive manufacturing process. Such selection may be performed using knowledge of the physical phenomenon and of the manufacturing settings (toolpath). In this example, the process data (temperature, melt pool area, time of printing or toolpath, laser parameters) acquired during the printing process, up to the time when a prediction is needed, is ranked based on an impact factor that penalizes (given a low impact factor) locations far away from the current location point in terms of a spatio-temporal distance. Therefore, very close locations but printed long time ago (or far locations but printed recently in time) are penalized. The N data points with highest impact factor are utilized to generate a data-driven model of melt pool temperature and area using the described analytics techniques.

In example embodiments, the WIF DDM 202 may be used to predict melt pool temperatures (T), and melt pool areas (A) at current melting/depositing locations along tool paths during a simulation of a 3D printer producing a product. The processor, for example, may be configured to calculate thermal gradients across the product at different points in time based on the predicted melt pool temperatures and area mapped onto a mesh of the 3D model of the product. The processor may also, for example, be configured to calculate levels of warping and residual stress at locations along the tool paths using appropriate finite element solvers processing the determined thermal gradients. Such warping and residual stress calculations may be produced faster using the WIF DDM compared to an alternative approach in which a finite element solver is used to determine temperatures for different areas.

As indicated previously, a further alternative embodiment may generate a data-driven model (DDM) based on an artificial neural network (ANN) that is trained using the previously described datasets determined for a product produced via a 3D printer.

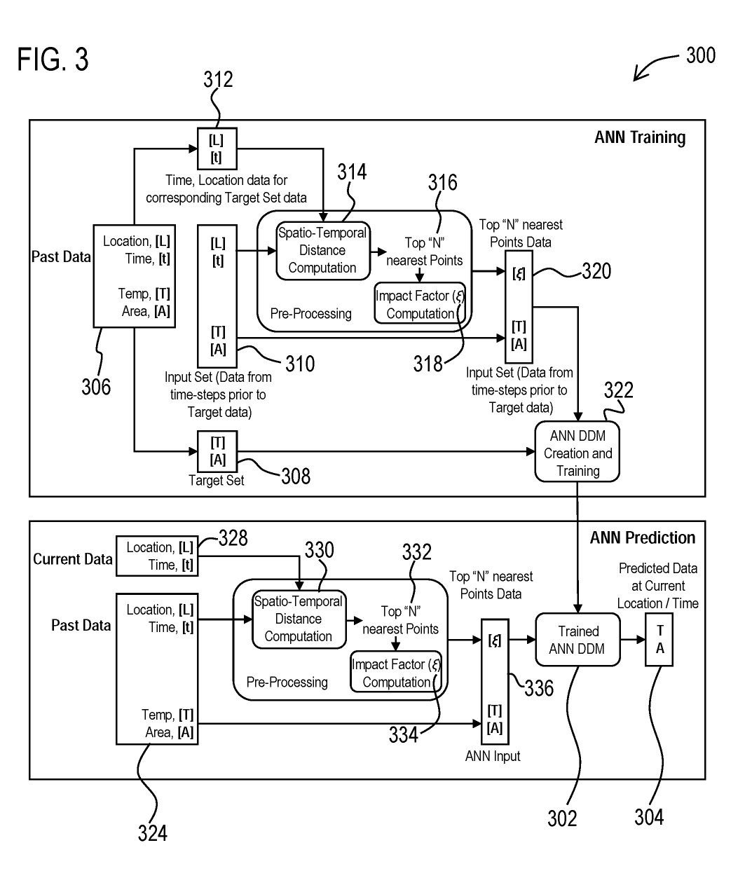

FIG. 3 shows the block diagram 300 of a process for generating and using an ANN DDM 302. As with the previously described WIF DDM, such an ANN DDM 302 may be created and used to generate predications 304 for melt pool temperatures and melt tool areas at points along the tool paths (used by a 3D printer to produce a product) by carrying out several steps.

In a first step (of a first set of steps involved with training the ANN DDM), the described processor 102 may be configured to divide past data 306 into three sets. Such past data may correspond to experimental data acquired from sensors in a 3D printer printing a product. For example, the experimental past data may correspond to data acquired via sensors of the 3D printer that detect a melt pool area (A) and a melt pool temperature (T) at different locations (L) and times (t) during the depositing/melting of material along tool paths defined by a set of instructions (e.g., G-code) generated from a 3D model of the product.

However, such past data may also correspond to calculated data generated from a simulation of the 3D printer printing the product which involves finite element analysis of a mesh of the 3D model. For example, the calculated past data may correspond to data acquired from finite element solvers that are configured to determine a melt pool area (A) and a melt pool temperature (T) at different locations (L) and times (t) during the simulation of depositing/melting of material along tool paths defined by a set of instructions (e.g., G-code) generated from a 3D model of the product.

The three sets divided from the past data may include: a) a target set 308, which includes melt pool temperature (T), and melt pool area (A) data for past time steps; b) an input set 310, which includes location, time, melt pool temperature (T), and melt pool area (A) data for several time steps prior to each target set data; and c) a supplement set 312, which includes time and location data for each target set data.

In a second step, the processor 102 may be configured to use time and location data from the supplement set 312, for each target set data 310, and time and location data from the input set 310 to compute spatio-temporal distances 314 between a point from the target set data 308 and points from the input set data 312 that were printed prior to a point of the target set data 308. For example, such a spatio-temporal distance (d) for a past point (i) may be calculated as follows:

d_{Lt}ⁱ=\sqrt{(L_{current}−Lₚₐₛₜⁱ)²+(t_{current}−tₚₐₛₜⁱ)²}

where t=time of printing, and L=location in x,y,z coordinates.

In a third step, the processor 102 may be configured to find “N” nearest points 316 for each point in the target set data 308 based on the computed spatio-temporal distances (d). N may be a user configurable parameter such as a value between 4-100, or other number based on the type of 3D print, the process parameters, and the complexity of the 3D model.

In a fourth step, the processor 102 may be configured to compute for each “N” nearest points for each point in the target set data 308, an impact factor (ξ) 318. Such an impact factor 318 may be a function of spatio-temporal distance (d) as follows:

$${ξ}^{i} = \frac{1}{{d}_{Lt}^{i}}$$

In a fifth step, the processor 102 may be configured to assemble for each point in the target set data 308 values for an input factor (ξ), melt pool temperature (T), and melt pool area (A), for the “N” nearest points in order to create an ANN input set 320.

In a sixth step, the processor 102 may be configured to use the ANN input set 320 and the target set 308 to train the artificial neural network (ANN) 322. Such a trained ANN may correspond to the previously described ANN DDM 302.

In example embodiments, the ANN DDM 302 may be used to predict melt pool temperatures (T), and melt pool areas (A) at current melting/depositing locations along tool paths during a simulation of a 3D printer producing a product. The processor, for example, may be configured to calculate thermal gradients across the product at different points in time based on the predicted melt pool temperatures and areas mapped onto a mesh of the 3D model of the product. The processor may also, for example, be configured to calculate levels of warping and residual stress at locations along the tool paths using appropriate finite element solvers processing the determined thermal gradients. Such warping and residual stress warping calculations may be produced faster using the ANN DDM compared to an alternative approach in which a finite element solver is used to determine temperatures for different areas.

The following describes additional steps that provide an example of how the previously described ANN DDM 302 may be used to predict melt pool temperatures (T), and melt pool areas (A) during a simulation of a 3D printer printing the previously described product. It should be appreciated that many of such simulations may be carried out by a user using the ANN DDM (via the software application 108) to determine which combination of tool paths, added heat sinks, and changes to process parameters may achieve an optimal or at least improved 3D printed product with respect to warpage and residual stress.

For example, as illustrated in FIG. 3, in a seventh step (during a simulation of a 3D printing of the product), the processor 102 may be configured to use past data 324 (e.g., locations and times where simulated printing has occurred) and current data 328 (e.g., location point and time, where the simulated printing is going to be performed next) to compute spatio-temporal distances (d) 330 for previously simulated printed points such as via the previously described equation:

d_{Lt}ⁱ=\sqrt{(L_{current}−Lₚₐₛₜⁱ)²+(t_{current}−tₚₐₛₜⁱ)²}

Also, in an eighth step, the processor 102 may be configured to find “N” nearest points 332 based on the computed space-time distances (d) with respect to the current data 328 location point. As discussed previously, N may be a user configurable parameter such as a value between 4-100, or other number based on the process parameters and the complexity of the 3D model.

In a ninth step 9, the processor 102 may be configured to compute for each “N” nearest points (with respect to the current point along the tool path), an impact factor (ξ) 334. As discussed previously with respect to generating the input set for training the ANN, such an impact factor 334 may be a function of spatio-temporal distance (d) as follows:

$${ξ}^{i} = \frac{1}{{d}_{Lt}^{i}}$$

In a tenth step, the processor 102 may be configured to assemble for the current data location point along the tool path, an input factor (ξ), melt pool temperature (T), and melt pool area (A), for the “N” nearest points in order to create an input set 336.

In an eleventh step, the processor 102 may be configured to apply the input set 336 on the trained artificial neural network (ANN DDM) 302 to compute (predict) a melt pool temperature (T) and a melt pool area (A) 304 for the current data 328 (location point) along the tool path.

The ANN training phase (e.g., steps one through six) may be repeated every certain number of printed locations, based on the accuracy of the ANN predictions compared to the measured data.

This approach enables the dynamic selection of data, from data measured up till the prediction, for: a) generation of a training set for training the artificial neural network; and b) generation of an input set for the artificial neural network to predict characteristics (temperature and area) of the melt pool that forms during the additive manufacturing process. Such data selection may be performed using knowledge of the physical phenomenon and of the manufacturing settings (toolpath). As discussed previous, the process data (temperature, melt pool area, time of printing or toolpath, laser parameters) acquired during the printing process, up to the time when a prediction is needed, is ranked based on an impact factor that penalizes (given a low impact factor) locations far away from the current location in terms of a spatio-temporal distance. Therefore, very close locations but printed long time ago (or far locations but printed recently in time) are penalized. The N data points with highest impact factor are then utilized to generate the artificial neural network based model for predicting the melt pool temperature and area.

These described processes for predicting melt pool temperatures and areas (using the DDMs described herein) may be performed repeatedly along the entire set of tool paths used to simulate the printing of a product via a 3D printer. Such temperature data for particular areas along the tool paths used to generate the product may also be used to determine temperature graduates between hot areas of recently deposited material, and cooler area for portion of the product deposited further back in time and distance. Such temperature gradients across the product at different times along the generation of the product may be used to simulate structural deformation of the product and residual stress via finite element solvers.

The described application software may also be configured to output through the display device 114 (and/or store in the data store 116) tables, images, and/or animations depicting the progressive buildup over time of the product being produced via an additive manufacturing process that illustrate the melt pool temperatures, calculated thermal gradients, structural deformation, and stress levels across different portions of the product. Examples of such images that may be produced from such data are illustrated in International PCT applications: PCT/US2017/015076 filed Jan. 26, 2007; and PCT/US2016/024695 filed Mar. 29, 2016, which are hereby incorporated herein by reference in their entirety.

In addition, it should also be appreciated that these described models may be sufficiently fast to enable their use during an additive manufacturing process. For example, the described predictions regarding melt point temperature and area for current locations that are about to be deposited/melted via a laser beam of a 3D printer, may be carried out by a controller associated with a 3D printer and be used to change laser power, flow rates, traverse speeds, and/or other process parameters, in order to maintain uniformity in the melting/depositing of material and to minimize warping and residual stress in the printed product. The described past data (e.g., temperatures, areas at different locations and times) used by the DDMs to make the predictions, may be acquired via sensors in the 3D printer.

Also, it should also be appreciate that these described models may be sufficiently fast to enable their use via software that produces tool paths for a 3D model. For example, the results of the previously described simulations using such 3D tool paths for a product, may be used to modify instructions for the 3D printer (G Code) that impact laser power, flow rate, and traverse speeds and/or other process parameters at different points along the tool paths in order to minimize warping and residual stress in the printed product.

In addition, it should be appreciated that in some cases the generated DDMs may be used to carry out different simulations of products from the same 3D model that were used to define the product for which the DDM was generated. However, it should also be appreciated that in some embodiments, the generated DDMs may be used with variations of the 3D model for which the DDM was original generated, and/or different or arbitrary 3D models. Also, in some embodiments, the DDMs may be generated using multiple different 3D models/printed products. For example, the artificial neural net of the ANN-DDM may be trained with data from a plurality of actual or simulated printings of products for a plurality of different 3D models and/or from a plurality of different 3D printers printing the same and/or different 3D model.

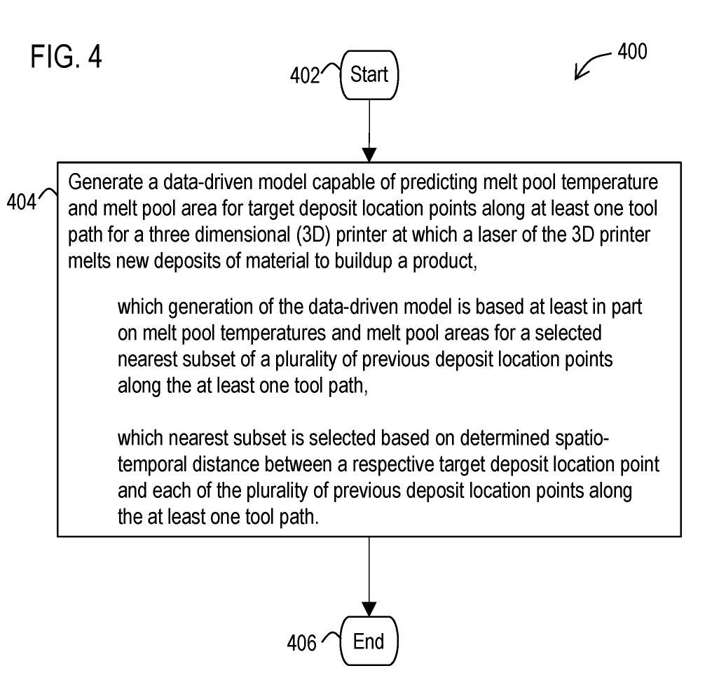

Referring now to FIG. 4, a methodology 400 is illustrated that facilitates modeling characteristics of a melt pool that forms during an additive manufacturing process. While the methodology is described as being a series of acts that are performed in a sequence, it is to be understood that the methodology may not be limited by the order of the sequence. For instance, unless stated otherwise, some acts may occur in a different order than what is described herein. In addition, in some cases, an act may occur concurrently with another act. Furthermore, in some instances, not all acts may be required to implement a methodology described herein.

The methodology may start at 402 and may include several acts carried out through operation of at least one processor. These acts may include an act 404 of generating a data-driven model capable of predicting melt pool temperature and melt pool area for target deposit location points along at least one tool path for a three dimensional (3D) printer at which a laser of the 3D printer melts new deposits of material to buildup a product. The generation of the data-driven model may be based at least in part on melt pool temperatures and melt pool areas for a selected nearest subset of a plurality of previous deposit location points along the at least one tool path. The nearest subset may be selected based on determined spatio-temporal distance between a respective target deposit location point and each of the plurality of previous deposit location points along the at least one tool path. At 406 the methodology may end.

Also, it should be appreciated that this described methodology may include additional acts and/or alternative acts corresponding to the features described previously with respect to the data processing system 100.

For example, the methodology may include an act of using the generated data-driven model to predict melt pool temperature and melt pool area for current locations along at least one tool path for a 3D printer at which a laser of the 3D printer melts new deposits of material to buildup the product. Also the methodology may include based at least in part on the predicted melt pool temperatures and melt pool areas, an act of determining structural deformation levels and residual stress levels in the product.

In an example embodiment, generating the data-driven model may be facilitated by carrying out several acts for each of the plurality of target deposit location points along at least one tool path. These acts may include determining spatio-temporal distances between the respective target deposit location point and each of the plurality of previous deposit location points along the at least one tool path. These acts may also include determining the selected nearest subset based on a predetermined number of nearest previous deposit location points with respect to the respective target deposit location point based on the spatio-temporal distances. In addition, these acts may include determining impact factors for each of the selected nearest subset of previous deposit location points based at least in part on the spatio-temporal distances. The data-driven model may be configured to predict the melt pool temperature and melt pool areas based at least in part on determined impact factors.

In an example embodiment (such as with respect to the previously described WIF-DDM), the act of determining the impact factors may further be based on the melt pool temperatures and melt pool areas associated respectively with each of the selected nearest subset of previous deposit location points when such points were current deposit locations at the point in time along the at least one tool path for the 3D printer at which the laser of the 3D printer melts new deposits of material to build up the product.

In another example embodiment (such as with respect to the previously described ANN-DDM), the generated data-driven model may include an artificial neural network. For such an embodiment, the described methodology may further include training the artificial neural network: using a target set of data and an input set of data. The target set of data may include melt pool temperatures and melt pool areas respectively associated with the target location points. The input set of data may include the determined impact factors, melt point temperatures, and melt pool areas associated respectively with each of the selected nearest subset of previous deposit location points when such previous deposit location points were current deposit locations at the point in time along the at least one tool path for the 3D printer at which the laser of the 3D printer melts new deposits of material to build up the product.

In some example embodiments, the methodology may include an act of determining melt pool temperatures and melt pool areas associated with the previous deposit location points using data provided by sensors of the 3D printer when printing the product.

Also, in some example embodiments, the methodology may include an act of determining melt pool temperatures and melt pool areas associated with the previous deposit location points using a finite element analysis solver and 3D mesh (such as a quadrilateral mesh) of a 3D model of the product.

As discussed previously, acts associated with the above-described methodologies (other than any described manual acts) may be carried out by one or more processors 102. Such processor(s) may be included in one or more data processing systems 100, for example, that execute from the memory 104 software instructions 106 operative to cause these acts to be carried out by the one or more processors. Further, it should be appreciated that software instructions may correspond to source code, byte code, runtime code, machine code, assembly language, Java, JavaScript, Python, C, C #, C++ or any other form of software instructions that can be programmed/configured to cause at least one processor to carry out the acts and features described herein.

It is important to note that while the disclosure includes a description in the context of a fully functional system and/or a series of acts, those skilled in the art will appreciate that at least portions of the mechanism of the present disclosure and/or described acts are capable of being distributed in the form of computer-executable instructions (e.g., the described software instructions and/or corresponding firmware instructions) contained within non-transitory machine-usable, computer-usable, or computer-readable medium in any of a variety of forms, and that the present disclosure applies equally regardless of the particular type of instruction or data bearing medium or storage medium utilized to actually carry out the distribution. Examples of non-transitory machine usable/readable or computer usable/readable mediums include: ROMs, EPROMs, magnetic tape, hard disk drives, SSDs, flash memory, CDs, DVDs, and Blu-ray disks. The computer-executable instructions may include a routine, a sub-routine, programs, applications, modules, libraries, and/or the like. Still further, results of acts of the methodologies may be stored in a computer-readable medium, displayed on a display device, and/or the like.

It should be understood that a processor that is described or claimed as being configured to carry out a particular described/claimed process or function may correspond to the combination 110 of the processor 102 with the software instructions 106 loaded/installed into the described memory 104 (volatile and/or non-volatile), which are currently being executed and/or are available to be executed by the processor to cause the processor to carry out the described/claimed process or function. Thus, a processor that is powered off or is executing other software, but has the described software instructions installed on a storage device in operative connection therewith (such as a hard drive or SSD) in a manner that is setup to be executed by the processor (when started by a user, hardware and/or other software), may also correspond to the described/claimed processor that is configured to carry out the particular processes and functions described/claimed herein.

Further, it should be understood that a processor that is described or claimed as being configured to carry out a particular described/claimed process or function may correspond to a microprocessor that is hard wired (e.g., an FPGA or ASIC microprocessor) and/or includes the described computer-executable instructions in the form of firmware programmed to carry out such a described/claimed process or function.

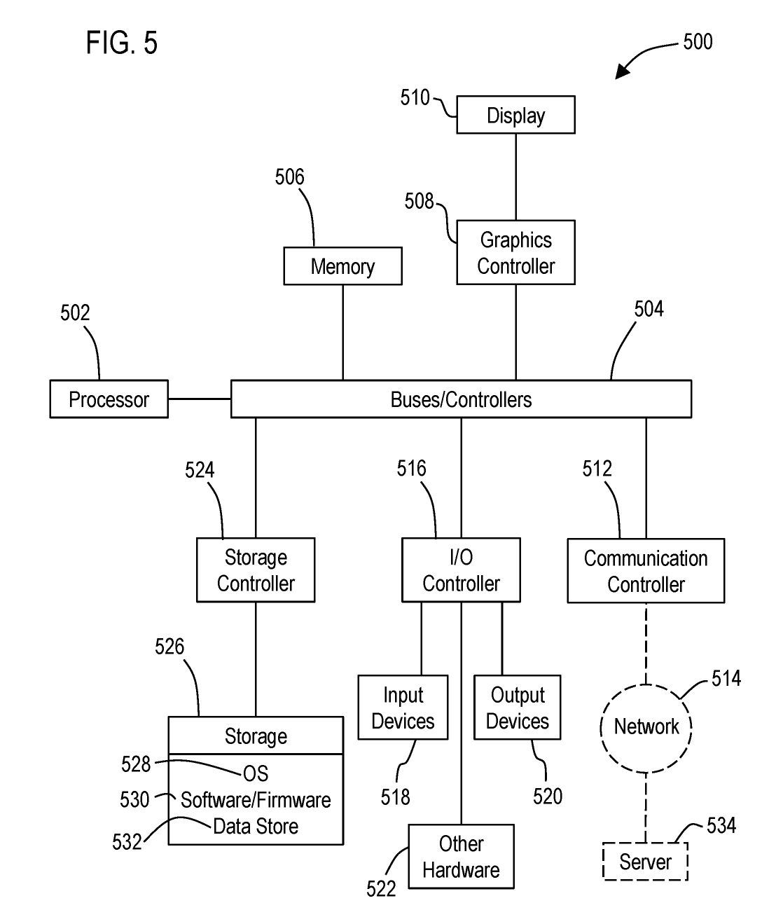

FIG. 5 illustrates a block diagram of a data processing system 500 (e.g., a computer system) in which an embodiment can be implemented, for example, as a portion of a product system, and/or other system operatively configured by computer-executable instructions, circuits, or otherwise to perform the functions and processes as described herein. The data processing system depicted includes at least one processor 502 (e.g., a CPU) that may be connected to one or more bridges/controllers/buses 504 (e.g., a north bridge, a south bridge). One of the buses 504, for example, may include one or more I/O buses such as a PCI Express bus. Also connected to various buses in the depicted example may include a main memory 506 (RAM) and a graphics controller 508. The graphics controller 508 may be connected to one or more display devices 510 (e.g., LCD or AMOLED display screen, monitor, VR headset, and/or projector). It should also be noted that the processor 502 may include a CPU cache memory. Further, in some embodiments one or more controllers (e.g., graphics, south bridge) may be integrated with the CPU (on the same chip or die). Examples of CPU architectures include IA-32, x86-64, and ARM processor architectures.

Other peripherals connected to one or more buses may include communication controllers 512 (Ethernet controllers, WiFi controllers, cellular controllers) operative to connect to a local area network (LAN), Wide Area Network (WAN), a cellular network, and/or other wired or wireless networks 514 or communication equipment.

Further components connected to various busses may include one or more I/O controllers 516 such as USB controllers, Bluetooth controllers, and/or dedicated audio controllers (connected to speakers and/or microphones). It should also be appreciated that various peripherals may be connected to the I/O controller(s) (via various ports and connections) including input devices 518 (e.g., keyboard, mouse, pointer, touch screen, touch pad, drawing tablet, trackball, buttons, keypad, game controller, gamepad, camera, microphone, scanners, motion sensing devices that capture motion gestures), output devices 520 (e.g., printers, speakers) or any other type of device that is operative to provide inputs to or receive outputs from the data processing system.

Also, it should be appreciated that many devices referred to as input devices or output devices may both provide inputs and receive outputs of communications with the data processing system. For example, the processor 502 may be integrated into a housing (such as a tablet) that includes a touch screen that serves as both an input and display device. Further, it should be appreciated that some input devices (such as a laptop) may include a plurality of different types of input devices (e.g., touch screen, touch pad, and keyboard). Also, it should be appreciated that other peripheral hardware 522 connected to the I/O controllers 516 may include any type of device, machine, or component that is configured to communicate with a data processing system.

Additional components connected to various busses may include one or more storage controllers 524 (e.g., SATA). A storage controller may be connected to a storage device 526 such as one or more storage drives and/or any associated removable media, which can be any suitable non-transitory machine usable or machine readable storage medium. Examples, include nonvolatile devices, volatile devices, read only devices, writable devices, ROMs, EPROMs, magnetic tape storage, hard disk drives, solid-state drives (SSDs), flash memory, optical disk drives (CDs, DVDs, Blu-ray), and other known optical, electrical, or magnetic storage devices drives and/or computer media. Also in some examples, a storage device such as an SSD may be connected directly to an I/O bus 504 such as a PCI Express bus.

A data processing system in accordance with an embodiment of the present disclosure may include an operating system 528, software/firmware 530, and data stores 532 (that may be stored on a storage device 526 and/or the memory 506). Such an operating system may employ a command line interface (CLI) shell and/or a graphical user interface (GUI) shell. The GUI shell permits multiple display windows to be presented in the graphical user interface simultaneously, with each display window providing an interface to a different application or to a different instance of the same application. A cursor or pointer in the graphical user interface may be manipulated by a user through a pointing device such as a mouse or touch screen. The position of the cursor/pointer may be changed and/or an event, such as clicking a mouse button or touching a touch screen, may be generated to actuate a desired response. Examples of operating systems that may be used in a data processing system may include Microsoft Windows, Linux, UNIX, iOS, and Android operating systems. Also, examples of data stores include data files, data tables, relational database (e.g., Oracle, Microsoft SQL Server), database servers, or any other structure and/or device that is capable of storing data, which is retrievable by a processor.

The communication controllers 512 may be connected to the network 514 (which may or may not be a part of a data processing system 500), which can be any local, wide area, remote, private, and/or public data processing system network or combination of networks, as known to those of skill in the art, including the Internet. Data processing system 500 can communicate over the network 514 with one or more other data processing systems such as a server 534 (which may in combination correspond to a larger data processing system). For example, a larger data processing system may correspond to a plurality of smaller data processing systems implemented as part of a distributed system in which processors associated with several smaller data processing systems may be in communication by way of one or more network connections and may collectively perform tasks described as being performed by a single larger data processing system. Thus, it is to be understood that when referring to a data processing system, such a system may be implemented across several data processing systems organized in a distributed system in communication with each other via a network.

It should also be understood that the term “controller” means any device, system or part thereof that controls at least one operation, whether such a device is implemented in hardware, firmware, software or any combination thereof. It should be noted that the functionality associated with any particular controller may be centralized or distributed, whether locally or remotely. The described processor and memory may be included in a controller. Further, a controller may correspond to the described data processing system or any other hardware circuit that is operative to control at least one operation.

In addition, it should be appreciated that data processing systems may include virtual machines in a virtual machine architecture or cloud environment. For example, the processor 502 and associated components may correspond to the combination of one or more virtual machine processors of a virtual machine operating in one or more physical processors of a physical data processing system. Examples of virtual machine architectures include VMware ESCi, Microsoft Hyper-V, Xen, and KVM.

Those of ordinary skill in the art will appreciate that the hardware depicted for the data processing system may vary for particular implementations. For example, the data processing system 500 in this example may correspond to a controller, computer, workstation, server, PC, notebook computer, tablet, mobile phone, and/or any other type of apparatus/system that is operative to process data and carry out functionality and features described herein associated with the operation of a data processing system, computer, processor, software components, and/or a controller discussed herein. The depicted example is provided for the purpose of explanation only and is not meant to imply architectural limitations with respect to the present disclosure.

Also, it should be noted that the processor described herein may correspond to a remote processor located in a data processing system such as a server that is remote from the display and input devices described herein. In such an example, the described display device and input device may be included in a client data processing system (which may have its own processor) that communicates with the server (which includes the remote processor) through a wired or wireless network (which may include the Internet). In some embodiments, such a client data processing system, for example, may execute a remote desktop application or may correspond to a portal device that carries out a remote desktop protocol with the server in order to send inputs from an input device to the server and receive visual information from the server to display through a display device. Examples of such remote desktop protocols include Teradici's PCoIP, Microsoft's RDP, and the RFB protocol. In another example, such a client data processing system may execute a web browser or thin client application. Inputs from the user may be transmitted from the web browser or thin client application to be evaluated on the server, rendered by the server, and an image (or series of images) sent back to the client data processing system to be displayed by the web browser or thin client application. Also in some examples, the remote processor described herein may correspond to a combination of a virtual processor of a virtual machine executing in a physical processor of the server.

Also, as used herein a processor corresponds to any electronic device that is configured via hardware circuits, software, and/or firmware to process data. For example, processors described herein may correspond to one or more (or a combination) of a microprocessor, CPU, FPGA, ASIC, or any other integrated circuit (IC) or other type of circuit that is capable of processing data in a data processing system, which may have the form of a controller board, computer, server, mobile phone, and/or any other type of electronic device. Further the phrase “at least one” before an element (e.g., a processor) that is configured to carry out more than one function/process may correspond to one or more elements (e.g., processors) that each carry out the functions/processes and may also correspond to two or more of the elements (e.g., processors) that respectively carry out different ones of the one or more different functions/processes.

As used herein, the terms “component” and “system” are intended to encompass hardware, software, or a combination of hardware and software. Thus, for example, a system or component may be a process, a process executing on a processor, or a processor. Additionally, a component or system may be localized on a single device or distributed across several devices.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of the data processing system 500 may conform to any of the various current implementations and practices known in the art.

Also, it should be understood that the words or phrases used herein should be construed broadly, unless expressly limited in some examples. For example, the terms “include” and “comprise,” as well as derivatives thereof, mean inclusion without limitation. The singular forms “a”, “an” and “the” are intended to include the plural forms as well, unless the context clearly indicates otherwise. Further, the term “and/or” as used herein refers to and encompasses any and all possible combinations of one or more of the associated listed items. The term “or” is inclusive, meaning and/or, unless the context clearly indicates otherwise. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Also, although the terms “first”, “second”, “third” and so forth may be used herein to refer to various elements, information, functions, or acts, these elements, information, functions, or acts should not be limited by these terms. Rather these numeral adjectives are used to distinguish different elements, information, functions or acts from each other. For example, a first element, information, function, or act could be termed a second element, information, function, or act, and, similarly, a second element, information, function, or act could be termed a first element, information, function, or act, without departing from the scope of the present disclosure.

In addition, the term “adjacent to” may mean: that an element is relatively near to but not in contact with a further element; or that the element is in contact with the further portion, unless the context clearly indicates otherwise.

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, act, or function is an essential element, which must be included in the claim scope: the scope of patented subject matter is defined only by the allowed claims. Moreover, none of these claims are intended to invoke a means plus function claim construction unless the exact words “means for” are followed by a participle.

1. A system for modeling characteristics of a melt pool that forms during an additive manufacturing process comprising:
at least one processor configured to generate a data-driven model capable of predicting melt pool temperature and melt pool area for target deposit location points along at least one tool path for a three dimensional (3D) printer at which a laser of the 3D printer melts new deposits of material to buildup a product;
wherein generation of the data-driven model is based at least in part on melt pool temperatures and melt pool areas for a selected nearest subset of a plurality of previous deposit location points along the at least one tool path; and
wherein the nearest subset is selected based on determined spatio-temporal distances between a respective target deposit location point and each of the plurality of previous deposit location points along the at least one tool path.

2. The system according to claim 1, wherein the at least one processor is configured to:
use the generated data-driven model to predict the melt pool temperature and the melt pool area for current locations along at least one tool path for a 3D printer at which a laser of the 3D printer melts new deposits of material to buildup the product; and
based at least in part on the predicted melt pool temperatures and melt pool areas, determine structural deformation levels and residual stress levels in the product.

3. The system according to claim 1, wherein the at least one processor is configured to generate the data-driven model via
for each of the plurality of target deposit location points along the at least one tool path:
determining the spatio-temporal distances between the respective target deposit location point and each of the plurality of previous deposit location points along the at least one tool path;
determining the selected nearest subset based on a predetermined number of nearest previous deposit location points with respect to the respective target deposit location point based on the spatio-temporal distances; and
determining impact factors for each of the selected nearest subset of previous deposit location points based at least in part on the spatio-temporal distances,
wherein the data-driven model is configured to predict the melt pool temperature and melt pool areas based at least in part on determined impact factors.

4. The system according to claim 3, wherein the at least one processor is configured to determine the impact factors based further on the melt pool temperatures and melt pool areas associated respectively with each of the selected nearest subset of previous deposit location points when such points were current deposit locations at the point in time along the at least one tool path for the 3D printer at which the laser of the 3D printer melts new deposits of material to build up the product.

5. The system according to claim 3, wherein the generated data-driven model includes an artificial neural network, and
wherein the at least one processor is configured to train the artificial neural network:
using a target set of data that includes melt pool temperatures and melt pool areas respectively associated with the target location points; and
using an input set of data that includes the determined impact factors, melt point temperatures, and melt pool areas associated respectively with each of the selected nearest subset of previous deposit location points when such previous deposit location points were current deposit locations at the point in time along the at least one tool path for the 3D printer at which the laser of the 3D printer melts new deposits of material to build up the product.

6. The system according to claim 1, wherein the at least one processor in configured to determine melt pool temperatures and melt pool areas associated with the previous deposit location points using data provided by sensors of the 3D printer when printing the product.

7. The system according to claim 1, wherein the at least one processor in configured to determine melt pool temperatures and melt pool areas associated with the previous deposit location points using a finite element analysis solver and a 3D mesh of a 3D model of the product.

8. A method for modeling characteristics of a melt pool that forms during an additive manufacturing process comprising:
through operation of at least one processor:
generating a data-driven model capable of predicting melt pool temperature and melt pool area for target deposit location points along at least one tool path for a three dimensional (3D) printer at which a laser of the 3D printer melts new deposits of material to buildup a product;
wherein generation of the data-driven model is based at least in part on melt pool temperatures and melt pool areas for a selected nearest subset of a plurality of previous deposit location points along the at least one tool path; and
wherein the nearest subset is selected based on determined spatio-temporal distances between a respective target deposit location point and each of the plurality of previous deposit location points along the at least one tool path.

9. The method according to claim 8, further comprising through operation of the at least one processor:
using the generated data-driven model to predict the melt pool temperature and the melt pool area for current locations along at least one tool path for a 3D printer at which a laser of the 3D printer melts new deposits of material to buildup the product; and
based at least in part on the predicted melt pool temperatures and melt pool areas, determining structural deformation levels and residual stress levels in the product.

10. The method according to claim 8, wherein generating the data-driven model is carried out via:
for each of the plurality of target deposit location points along at least one tool path:
determining the spatio-temporal distances between the respective target deposit location point and each of the plurality of previous deposit location points along the at least one tool path;
determining the selected nearest subset based on a predetermined number of nearest previous deposit location points with respect to the respective target deposit location point based on the spatio-temporal distances; and
determining impact factors for each of the selected nearest subset of previous deposit location points based at least in part on the spatio-temporal distances,
wherein the data-driven model is configured to predict the melt pool temperature and melt pool areas based at least in part on determined impact factors.

11. The method according to claim 10, wherein determining the impact factors is further based on the melt pool temperatures and melt pool areas associated respectively with each of the selected nearest subset of previous deposit location points when such points were current deposit locations at the point in time along the at least one tool path for the 3D printer at which the laser of the 3D printer melts new deposits of material to build up the product.

12. The method according to claim 10, wherein the generated data-driven model includes an artificial neural network, and
further comprising training the artificial neural network:
using a target set of data that includes melt pool temperatures and melt pool areas respectively associated with the target location points; and
using an input set of data that includes the determined impact factors, melt point temperatures, and melt pool areas associated respectively with each of the selected nearest subset of previous deposit location points when such previous deposit location points were current deposit locations at the point in time along the at least one tool path for the 3D printer at which the laser of the 3D printer melts new deposits of material to build up the product.

13. The method according to claim 8, further comprising through operation of the at least one processor, determining melt pool temperatures and melt pool areas associated with the previous deposit location points using data provided by sensors of the 3D printer when printing the product.

14. The method according to claim 8, further comprising through operation of the at least one processor, determining melt pool temperatures and melt pool areas associated with the previous deposit location points using a finite element analysis solver and a 3D mesh of a 3D model of the product.

15. A non-transitory computer readable medium encoded with executable instructions that, when executed, cause at least one processor to:
generate a data-driven model capable of predicting melt pool temperature and melt pool area—for target deposit location points along at least one tool path for a three dimensional (3D) printer—at which a laser of the 3D printer melts new deposits of material to buildup a product;
wherein generation of the data-driven model is based at least in part on melt pool temperatures and melt pool areas for a selected nearest subset of a plurality of previous deposit location points along the at least one tool path; and
wherein the nearest subset is selected based on determined spatio-temporal distances between a respective target deposit location point and each of the plurality of previous deposit location points along the at least one tool path.

16. The non-transitory computer readable medium according to claim 15, wherein the executable instructions, when executed, cause the at least one processor to:
use the generated data to predict the melt pool temperature and the melt pool area for current locations—along at least one tool path for a 3D printer at which a laser of the 3D printer melts new deposits of material to buildup the product; and
based at least in part on the predicted melt pool temperatures and melt pool areas, determine structural deformation levels and residual stress levels in the product.

17. The non-transitory computer readable medium according to claim 15, wherein the executable instructions, when executed, cause the at least one processor to generate the data-driven model via:
for each of the plurality of target deposit location points along the at least one tool path:
determining the spatio-temporal distances between the respective target deposit location point and each of the plurality of previous deposit location points along the at least one tool path;
determining the selected nearest subset based on a predetermined number of nearest previous deposit location points with respect to the respective target deposit location point based on the spatio-temporal distances; and
determining impact factors for each of the selected nearest subset of previous deposit location points based at least in part on the spatio-temporal distances,
wherein the data-driven model is configured to predict the melt pool temperature and melt pool areas based at least in part on determined impact factors.

18. The non-transitory computer readable medium according to claim 17, wherein the executable instructions, when executed, cause the at least one processor to determine the impact factors based further on the melt pool temperatures and melt pool areas associated respectively with each of the selected nearest subset of previous deposit location points when such points were current deposit locations at the point in time along the at least one tool path for the 3D printer at which the laser of the 3D printer melts new deposits of material to build up the product.

19. The non-transitory computer readable medium according to claim 17, wherein the generated data-driven model includes an artificial neural network, and
wherein the instructions, when executed, cause the at least one processor to train the artificial neural network:
using a target set of data that includes melt pool temperatures and melt pool areas respectively associated with the target location points; and
using an input set of data that includes the determined impact factors, melt point temperatures, and melt pool areas associated respectively with each of the selected nearest subset of previous deposit location points when such previous deposit location points were current deposit locations at the point in time along the at least one tool path for the 3D printer at which the laser of the 3D printer melts new deposits of material to build up the product.

20. The non-transitory computer readable medium according to claim 15, wherein the executable instructions, when executed, cause the at least one processor to determine melt pool temperatures and melt pool areas associated with the previous deposit location points using data provided by sensors of the 3D printer when printing the product.
